(19) United States
(12) Patent Application Publication
(10) Pub. No.: US 2010/0317325 A1
(43) Pub. Date: Dec. 16, 2010

(54) RETRIEVING UNIQUE MESSAGE PARTS ON A MOBILE COMPUTING DEVICE

(75) Inventors: Shivakumar Seetharaman, Snoqualmie, WA (US); Selvaraj Nalliah, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/485,354

(22) Filed: Jun. 16, 2009

(51) Int. Cl. H04L 12/58

(52) U.S. Cl. 455/412.1

(57) ABSTRACT

Embodiments are provided for retrieving unique message parts on a mobile computing device. One or more message parts, containing unique portions of a message, may be requested by the mobile computing device. After the one or more message parts are received at the mobile computing device, the one or more message parts are rendered on the mobile computing device.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Data messages, such as electronic mail messages, may be composed of one or more message parts, where each part corresponds to a response from a sender. When these data messages are requested by mobile computing devices from a message server, they often include redundant information (i.e., message parts) consisting of earlier messages received in an ongoing “thread.” The redundant information may make the retrieval of an entire message which contains a thread time consuming and hinder the reading experience of a reader who must re-read the same text in the message. Furthermore, the redundant information making up a message takes up additional storage space on mobile computing devices which may have limited resources for processing, storing (e.g., limited memory), and displaying (e.g., limited screen size) such messages. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for retrieving unique message parts on a mobile computing device. One or more message parts, containing unique portions of a message, may be requested by the mobile computing device. After the one or more message parts are received at the mobile computing device, the one or more message parts are rendered on the mobile computing device.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for retrieving unique message parts on a mobile computing device, in accordance with various embodiments;

FIG. 2 is a block diagram illustrating a mobile computing device environment which may be utilized for retrieving unique message parts on a mobile computing device in accordance with various embodiments; and

FIG. 3 is a flow diagram illustrating a routine for retrieving unique message parts on a mobile computing device, in accordance with various embodiments.

### DETAILED DESCRIPTION

Embodiments are provided for retrieving unique message parts on a mobile computing device. One or more message parts, containing unique portions of a message, may be requested by the mobile computing device. After the one or more message parts are received at the mobile computing device, the one or more message parts are rendered on the mobile computing device.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

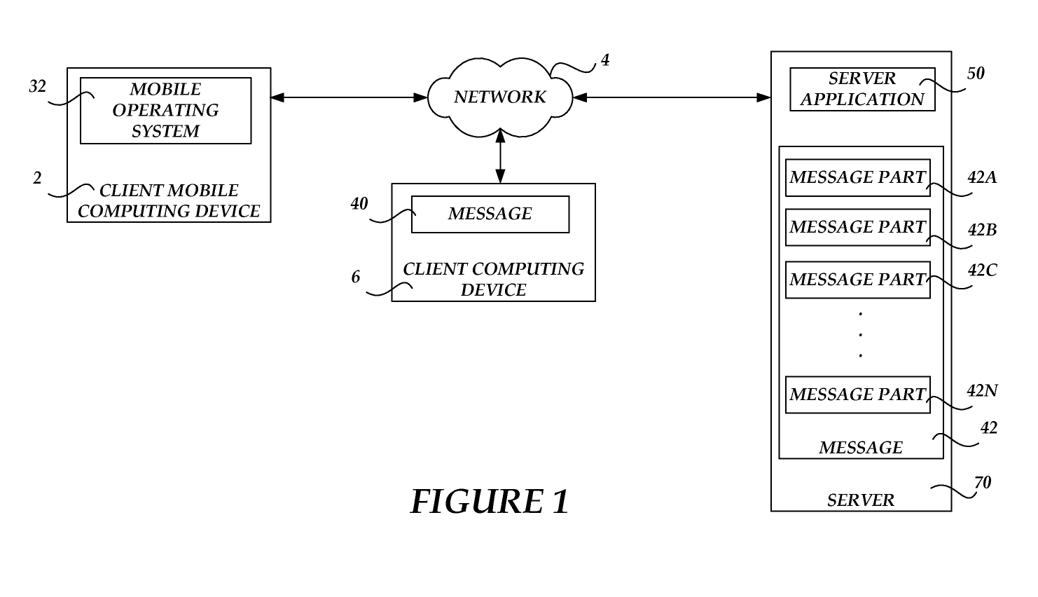

Referring now to the drawings, in which like numerals represent like elements through the several figures, various aspects of the present invention will be described. FIG. 1 is a block diagram illustrating a network architecture for retrieving messages as unique message parts on a mobile computing device, in accordance with various embodiments. The network architecture includes a client mobile computing device 2 in communication with a client computing device 6 and a server computer 70 over a network 4. In accordance with various embodiments, the network 4 may comprise a local network or a wide area network (e.g., the Internet).

The client mobile computing device 2 may include a mobile operating system 32. In accordance with various embodiments, the mobile operating system 32 may comprise the WINDOWS MOBILE software which is manufactured by MICROSOFT CORPORATION of Redmond Wash. It should be appreciated that other operating systems and/or application programs from other manufacturers may be utilized in accordance with the various embodiments described herein.

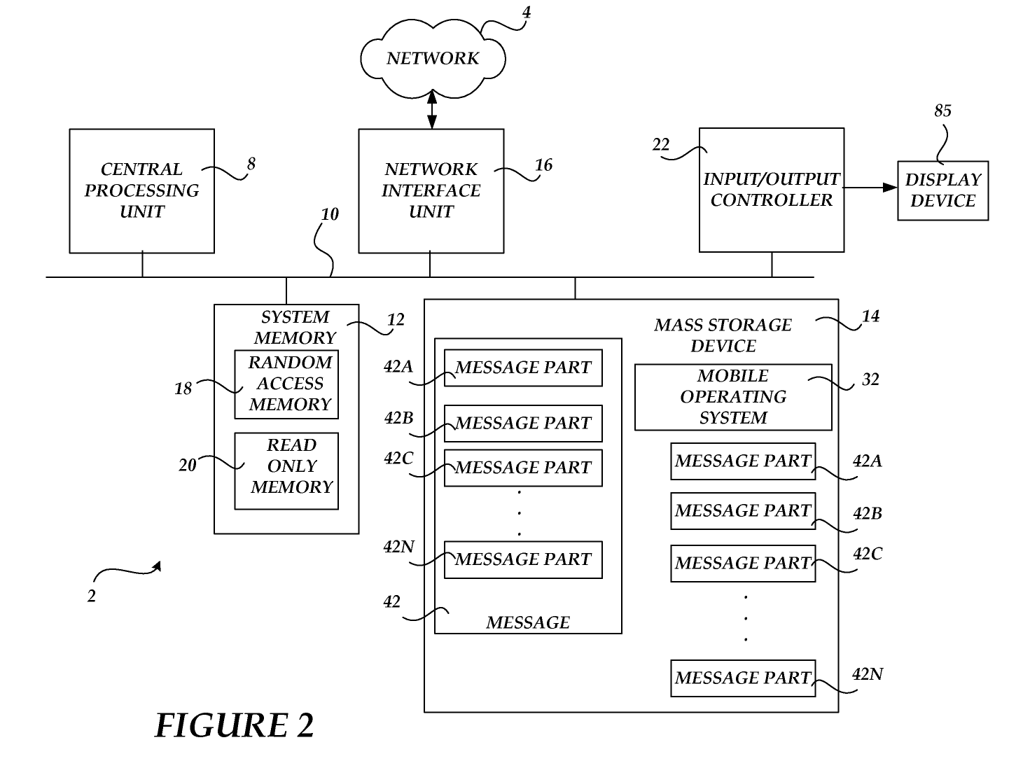

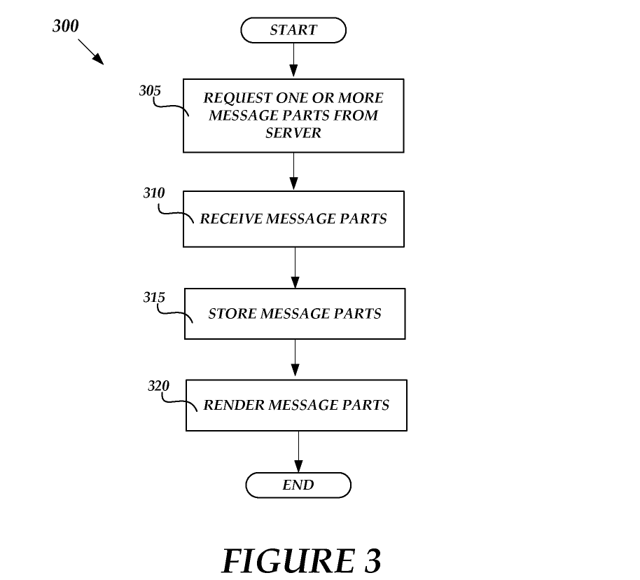

In accordance with various embodiments, the client mobile computing device 2 may comprise a mobile or portable computer or other type of computer capable of executing one or more application programs including, but not limited to, a laptop computer and a “smartphone” (i.e., a mobile phone having computer functionality and/or which is capable of running operating system software to provide a standardized interface and platform for application developers). In accordance with various embodiments (which will be described in greater detail in the discussion of FIGS. 2-3), the mobile operating system 32 may be utilized to retrieve unique message parts from the server 70 on the client mobile computing device 2.

The client computing device 6 may comprise a general purpose desktop, laptop, handheld, tablet, or other type of computer capable of executing one or more application programs. Similar to the mobile client computing device 2, the client computing device 6 may also comprise a smartphone. The client computing device 6 may store a message 40 (which may comprise an electronic mail message) for sending to the mobile client computing device 6 through the server 70. In accordance with various embodiments, the message 40 stored on the client computing device 6 may include a messaging conversation (or “thread”) consisting of non-unique message “parts” (not shown). As defined herein, a non-unique message part is a portion of a message or message thread which repeats previously presented content. Thus, a second message part in the message 40 may include content previously presented in a first message part. In particular, a second message part in the message 40 may include an initial electronic mail message (i.e., the content of the first message part) as well as a reply to the initial electronic message.

The server computer 70 may include a server application 50 and a message 42. In accordance with an embodiment, the message 42 may comprise an electronic mail message thread and includes message parts 42A, 42B, and 42C-42N. In accordance with an embodiment, the server application 50 may comprise the EXCHANGE SERVER messaging and collaboration software which is manufactured by MICROSOFT CORPORATION of Redmond Wash. It should be appreciated that other application programs from other manufacturers may also be utilized in accordance with the various embodiments described herein. In accordance with various embodiments, the server application 50 may be configured to receive the message 40 (containing non-unique message parts from the client computing device 6 and convert the message 40 into a message containing unique message parts.

As defined herein, a unique message part is a portion of a message or message thread which does not repeat previously presented content. Thus, the message part 42N does not include content previously presented in the message part 42C, the message part 42C does not include content previously presented in the message part 42B, and the message part 42B does not include content previously presented in the message part 42A. For example, in accordance with various embodiments, the message 42 containing message parts 42A, 42B, and 42C-42N may comprise a thread consisting of an initial electronic mail message (i.e., the message part 42A) and subsequent replies to the message part 42A (i.e., the unique message parts 42B and 42C-42N). Unlike the message parts in the message 40 (discussed above), the replies to the message part 42A do not include the initial electronic message or any previous replies (as applicable).

### Exemplary Operating Environment

Referring now to FIG. 2, the following discussion is intended to provide a brief, general description of a suitable computing environment in which various illustrative embodiments may be implemented. While various embodiments will be described in the general context of program modules that execute in conjunction with program modules that run on an operating system on a computing device, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 2 shows the client mobile computing device 2 which may include a mobile or portable computer or other type of computer capable of executing one or more application programs including, but not limited to, a laptop computer and a “smartphone” (i.e., a mobile phone having computer functionality and/or which is capable of running operating system software to provide a standardized interface and platform for application developers). The client mobile computing device 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20.

The client mobile computing device 2 may further include a mass storage device 14 for storing the mobile operating system 32, and the message parts 42A, 42B, and 42C-42N either individually or collectively (as the message 42). In accordance with an embodiment, the mobile operating system 32 may be utilized to individually open each of the message parts 42A, 42B, and 42C-42N stored on the mass storage device 14, for viewing on the client mobile computing system 2, and to also reconstruct a message (e.g., into a single message thread) utilizing the message parts 42A, 42B, and 42C-42N stored on the mass storage device 14. It will be appreciated that in accordance with another embodiment, the mobile operating system 32 may be utilized to reconstruct messages from message parts without using any of the message parts 42A, 42B, and 42C-42N stored on the mass storage device 14. In particular, the mobile operating system 32 may be utilized to dynamically (i.e., automatically) reconstruct the message 42 as the message parts 42A, 42B, and 42C-N are being received from the server computer 70. In accordance with another embodiment, the mobile operating system 32 may be utilized to reconstruct the message 42 using one or more of the message parts 42A, 42B, and 42C-N received from the server 70 and one or more of the message parts 42A, 42B, and 42C-N stored on the mass storage device 14. Each of the aforementioned embodiments will be discussed in greater detail below with respect to FIG. 3.

The mass storage device 14 is connected to the CPU 8 through a mass storage controller (not shown) connected to the bus 10. The mass storage device 14 and its associated computer-readable media provide non-volatile storage for the client mobile computing device 2. Although the description of computer-readable media contained herein refers to a mass storage device, such as a hard disk or CD-ROM drive, it should be appreciated by those skilled in the art that computer-readable media can be any available media that can be accessed or utilized by the client mobile computing device 2. By way of example, and not limitation, computer-readable media may comprise computer storage media and communication media.

Computer storage media includes volatile and non-volatile, removable and non-removable hardware storage media implemented in any physical method or technology for the storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, which can be used to store the desired information and which can be accessed by the client mobile computing device 2. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as a computer program product.

According to various embodiments of the invention, the client mobile computing device 2 may operate in a networked environment using logical connections to remote computers through the network 4. The client mobile computing device 2 may connect to the network 4 through a network interface unit 16 connected to the bus 10. It should be appreciated that the network interface unit 16 may also be utilized to connect to other types of networks and remote computing systems. In accordance with various embodiments, the network interface unit 16 may include a wireless radio (not shown) for establishing and maintaining communication over the network 4. The client mobile computing device 2 may also include an input/output controller 22 for receiving and processing input from a number of input types, including a keyboard, mouse, pen, stylus, finger, and/or other means (not shown). Similarly, the input/output controller 22 may provide output to a display device 70 as well as a printer, or other type of output device (not shown). It should be understood that the client mobile computing device 2 may also include other conventional components (not shown) such as a power supply (e.g., a removable or non-removable battery) and a real-time clock. It should be appreciated that the client computer 6 and the server computer 70 shown in FIG. 1 may include many of the conventional components shown with respect to the client mobile computing device 2, discussed above.

FIG. 3 is a flow diagram illustrating a routine 300 for retrieving unique message parts on a mobile computing device, in accordance with various embodiments. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 3 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 300 begins at operation 305, where the mobile operating system 32 executing on the client mobile computing device 2 requests one or more of the message parts 42A, 42B, and 42C-42N from the server 70. In particular, the mobile operating system 32 may send a synchronization request to the server computer 70 a unique message part which may be needed to combine with other message parts in order reconstruct the message 42. In accordance with an embodiment, the mobile operating system 32 may be utilized to request only those message parts which have not been previously stored on the client computing device 2. Thus, in accordance with this embodiment, only the message parts which may be needed to reconstruct the message 42 are requested from the server 70.

From operation 305, the routine 300 continues to operation 310, where the mobile operating system 32 receives the requested one or more message parts 42A, 42B, and 42C-42N from the server computer 70. In accordance with various embodiments, some or all of the message parts 42A, 42B, and 42C-42N may comprise a reply message in an electronic mail message thread.

From operation 310, the routine 300 continues to operation 315, where mobile operating system 32 stores one or more of the message parts 42A, 42B, and 42C-42N. In particular, the mobile operating system 32 may store one or more of the message parts 42A, 42B, and 42C-42N and utilize them to render the individual message parts or alternatively, the entire message 42, on the client mobile computing device 2. It should be understood that operation 315 is optional and that in accordance with other embodiments the mobile operating system 32 may utilized to dynamically reconstruct the message 32 without using stored message parts.

From operation 315, the routine 300 continues to operation 320 where the mobile operating system 32 renders the one or more message parts 42A, 42B, and 42C-42N received from the server computer 70 for display or optional storage on the client mobile computing device 2. In accordance with one embodiment, the mobile operating system 32 may be utilized to render the message parts by utilizing solely the message parts 42A, 42B, and 42C-42N to dynamically reconstruct the message 42 for display on the client mobile computing device 2. In accordance with another embodiment, the mobile operating system 32 may be utilized to render the message parts by determining if one or more of the message parts 42A, 42B, and 42C-42N have been previously stored on the client mobile computing device 2. If so, the message 42 may be reconstructed from the stored message parts and the message parts received from the server computer 70. It should be understood that if the mobile operating system 32 is unable to reconstruct the message 42 from the message parts 42A, 42B, and 42C-42N (e.g., due to a corrupted message part), the entire message 42 may be retrieved from the server computer 70. In accordance with another embodiment, the mobile operating system 32 may be utilized to render the one or more received message parts 42A, 42B, and 42C-42N by storing them individually on the client mobile computing device 2. When the individually stored message parts 42A, 42B, and 42C-42N are opened on the client mobile computing device 2, they will each individually contain unique portions of the message 42. From operation 320, the routine 300 then ends.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method of retrieving unique message parts on a mobile computing device, comprising:
requesting, by the mobile computing device, at least one message part from a server computer, wherein the at least one message part comprises a unique portion of a message, the message comprising a plurality of unique message parts;
receiving, at the mobile computing device, the at least one message part from the server computer; and
rendering the at least one message part on the mobile computing device.

2. The method of claim 1, wherein rendering the at least one message part on the mobile computing device comprises reconstructing the message utilizing the at least one message part received from the server computer.

3. The method of claim 1 further comprising storing the at least one message part on the mobile client computing device.

4. The method of claim 3 further comprising determining that at least one other message part is stored on the mobile computing device.

5. The method of claim 4, wherein rendering the at least one message part on the mobile computing device comprises reconstructing the message utilizing the at least one message part received from the server computer and the at least one other message part stored on the mobile computing device.

6. The method of claim 1, wherein rendering the at least one message part on the mobile computing device comprises rendering only a single message part comprising a unique portion of the message on the mobile computing device.

7. The method of claim 1, wherein receiving, at the mobile computing device, the at least one message part from the server computer comprises receiving at least one reply in an electronic mail message thread.

8. A mobile computing device for retrieving unique message parts on a mobile computing device, comprising:
a memory for storing executable program code; and
a processor, functionally coupled to the memory, the processor being responsive to computer-executable instructions contained in the program code and operative:
to request at least one message part from a server computer, wherein the at least one message part comprises a unique portion of a message, the message comprising a plurality of unique message parts;
to receive the at least one message part from the server computer; and
to render the at least one message part.

9. The mobile computing device of claim 8, wherein the processor, in rendering the at least one message part, is operative to reconstruct the message utilizing the at least one message part received from the server computer.

10. The mobile computing device of claim 8, wherein the processor is further operative to store the at least one message part.

11. The mobile computing device of claim 10, wherein the processor is further operative to determine that at least one other message part is stored.

12. The mobile computing device of claim 11, wherein the processor, in rendering the at least one message part comprising the unique portion of the message, is operative to reconstruct the message utilizing the at least one message part received from the server computer and the at least one other stored message part.

13. The mobile computing device of claim 8, wherein the processor, in rendering the at least one message part comprising the unique portion of the message, is operative to render only a single message part comprising a unique portion of the message on the mobile computing device.

14. The mobile computing device of claim 8, wherein the processor, in receiving the at least one message part, is operative to receive at least one reply in an electronic mail message thread.

15. A computer-readable storage medium comprising computer executable instructions which, when executed by a mobile computing device, will cause the mobile computing device to perform a method of retrieving unique message parts on a mobile computing device, comprising:
sending, by the mobile computing device, a synchronization request to a server computer for at least one message part, the at least one message part comprising a unique portion of an electronic mail message, the electronic mail message comprising plurality of unique message parts;
receiving, at the mobile computing device, the at least one message part; and
rendering the at least the one message part on the mobile computing device.

16. The computer-readable storage medium of claim 15, wherein rendering the at least the one message part on the mobile computing device comprises reconstructing the electronic mail message utilizing the at least one message part received from the server computer.

17. The computer-readable storage medium of claim 15 further comprising storing the at least one message part on the mobile client computing device.

18. The computer-readable storage medium of claim 17 further comprising determining that at least one other message part is stored on the mobile computing device.

19. The computer-readable storage medium of claim 18, wherein rendering the at least the one message part on the mobile computing device comprises reconstructing the electronic mail message utilizing the at least one message part received from the server computer and the at least one other message part stored on the mobile computing device.

20. The computer-readable storage medium of claim 15, wherein rendering the at least one message part on the mobile computing device comprises rendering only a single message part comprising a unique portion of the message on the mobile computing device.
